(19) United States
(12) Patent Application Publication
(10) Pub. No.: US 2017/0017680 A1
(43) Pub. Date: Jan. 19, 2017

(54) METHOD FOR HANDLING WRITES IN DATABASE CLUSTERS WITH TEMPORARILY DISJOINT NODES

(71) Applicant: Codership Oy, Helsinki (FI)

(72) Inventors: Seppo Jaakola, Helsinki (FI); Teemu Ollakka, Oulu (FI); Alexey Yurchenko, Helsinki (FI)

(21) Appl. No.: 14/797,811

(22) Filed: Jul. 13, 2015

(51) Int. Cl. G06F 17/30

(52) U.S. Cl. CPC G06F 17/30377; G06F 17/30598

(57) ABSTRACT

A method for use in a multi-cluster database arrangement is provided. A given transaction is received at a given node of the multi-cluster database arrangement. A database object being modified by the given transaction is determined, whilst executing the given transaction at the given node. Subsequently, a given owner cluster assigned to the database object is determined. Next, it is determined whether or not the given node is included in a primary component of the given owner cluster. The given transaction is committed at the given node for the given owner cluster, when the given node is included in the primary component of the given owner cluster. The aforementioned method is performed when the given transaction is received during a time the given node is communicably disjoint from at least one other node of the given owner cluster.

### TECHNICAL FIELD

The present disclosure generally relates to data synchronization, and more specifically, to methods for use in multi-cluster database arrangements. Moreover, the present disclosure relates to computing apparatus for use in multi-cluster database arrangements.

### BACKGROUND

A typical database cluster includes a plurality of database servers, which are often distributed geographically. In the database cluster, the database servers communicate with each other for data replication and data synchronization purposes. The term “data replication” typically refers to electronic copying of data from one computer or server to other computers or servers. Data replication and data synchronization enable users to access a same level of information and to access data relevant to their tasks without interfering with tasks of other users.

A synchronous database cluster provides strict consistency for data. In other words, all database servers of the synchronous database cluster apply and acknowledge each transaction. This requires constant network connectivity between these database servers. If a database server loses connectivity with other database servers, it becomes disjoint and cannot accept transactions from clients any more. Only after the network connectivity has been re-established, the database server can begin to serve its clients again.

The strict requirement for constant network connectivity can be a problem in real-life database cluster deployments, which may use unreliable networking. Still, it may be necessary, for example for business reasons, to allow writes even in disjoint servers. As an example, a database arrangement in a retail sales business may include a central head quarter server and multiple retail store servers residing behind unreliable network connections. In such a case, it may be important to continue retail sales at the retail store servers even when a network connection to the central head quarter server is lost temporarily. For this reason, the database arrangement should allow at least some level of writes in such disjoint servers.

However, when write operations are performed in disjoint servers, there might arise a situation when same data elements are modified by substantially concurrent transactions at different servers. Such a situation gives rise to write conflicts when data is synchronized between the disjoint servers. Some examples of possible write conflicts that can occur in any typical asynchronous database cluster are as follows:

(i) an update conflict occurs when an update operation fails because an old row is not found any more in a given database table;
(ii) a delete conflict occurs when a delete operation fails because a matching row is not found in a given database table; and
(iii) a uniqueness conflict occurs when an insert or update operation fails because at least some of unique key constraints are violated.

In conventional asynchronous database clusters, it is possible to implement handlers for resolving such write conflicts to some extent. However, there exists no complete solution for resolving all possible write conflicts in asynchronous database clusters. Therefore, such a database cluster cannot serve its clients in a reliable manner, and is not suitable for all practical applications.

### SUMMARY

The present disclosure seeks to provide an improved method for use in a multi-cluster database arrangement.

A further aim of the present disclosure is to at least partially overcome at least some of the problems of the prior art, as discussed above.

In a first aspect, embodiments of the present disclosure provide a method for use in a multi-cluster database arrangement, the multi-cluster database arrangement comprising a plurality of database clusters, wherein at least two database clusters of the multi-cluster database arrangement are overlapping, wherein each database object defined in the multi-cluster database arrangement is assigned an owner cluster from amongst the plurality of database clusters, the method comprising:

(a) receiving a given transaction at a given node of the multi-cluster database arrangement;
(b) determining a database object being modified by the given transaction, whilst executing the given transaction at the given node;
(c) determining a given owner cluster assigned to the database object;
(d) determining whether or not the given node is included in a primary component of the given owner cluster; and
(e) committing the given transaction at the given node for the given owner cluster, when the given node is included in the primary component of the given owner cluster,
further wherein (b) to (e) are performed when the given transaction is received at (a) during a time the given node is communicably disjoint from at least one other node of the given owner cluster.

In a second aspect, embodiments of the present disclosure provide a computing apparatus comprising:

a processor;

a memory coupled to the processor; and

a network interface coupled to the processor,

wherein the processor is configured to:

(i) receive a given transaction;

(ii) determine a database object being modified by the given transaction, whilst executing the given transaction;

(iii) determine a given owner cluster assigned to the database object;

(iv) determine whether or not the computing apparatus is included in a primary component of the given owner cluster; and

(v) commit the given transaction for the given owner cluster, when the computing apparatus is included in the primary component of the given owner cluster,

further wherein (ii) to (v) are performed when the given transaction is received at (i) during a time the computing apparatus is communicably disjoint from at least one other node of the given owner cluster.

In a third aspect, embodiments of the present disclosure provide a method for use in a multi-cluster database arrangement, the multi-cluster database arrangement comprising a plurality of database clusters, wherein at least two database clusters of the multi-cluster database arrangement are overlapping, the method comprising:

assigning, to each database object defined in the multi-cluster database arrangement, an owner cluster from amongst the plurality of database clusters; and

defining a primary component of each database cluster, wherein a primary component of a given database cluster includes at least one node of the given database cluster that remains active and is allowed to commit transactions modifying database objects that are assigned the given database cluster as their owner cluster, when the at least one node is disjoint from other nodes of the given database cluster.

Embodiments of the present disclosure substantially eliminate or at least partially address the aforementioned problems in the prior art, and enable conflict-free transaction processing and synchronization at temporarily disjoint nodes in a multi-cluster database arrangement.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an example multi-cluster database arrangement, in accordance with an embodiment of the present disclosure;

FIG. 2 is a schematic illustration of a computing apparatus for use in a multi-cluster database arrangement, in accordance with an embodiment of the present disclosure;

FIGS. 3A, 3B, 3C and 3D collectively are a schematic illustration of an example multi-cluster database arrangement and processing performed thereat under various scenarios, in accordance with an embodiment of the present disclosure;

FIGS. 4A and 4B collectively are a schematic illustration of processing performed at a multi-cluster database arrangement, in accordance with an embodiment of the present disclosure; and

FIGS. 5A and 5B collectively are an illustration of steps of a method for use in a multi-cluster database arrangement, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

### GLOSSARY

Brief definitions of terms used throughout the present disclosure are given below.

The term “database” generally refers to an organized collection of machine-readable data.

The term “Database Management System (DBMS)” generally refers to a software application specially designed to manage and manipulate resources in a database. The DBMS provides an interface, such as an Application Programming Interface (API) or a Structured Query Language (SQL) for performing basic database operations, such as create, read, update, and delete (often referred to as CRUD).

The term “database cluster” generally refers to a plurality of database servers or nodes, wherein each database server or node includes a DBMS. Each node resides in its own process space and may reside on the same server or different servers. Each node maintains a copy of a portion or all of resources from other nodes within the database cluster. The nodes are configured to communicate with other nodes, in order to synchronize the resources such that all copies of a particular resource contain the same data.

The term “multi-cluster database arrangement” generally refers to a database arrangement that includes a plurality of database clusters, wherein at least two database clusters are overlapping. When two database clusters overlap, they have at least one node in common. It is to be noted here that there can be more than two overlapping database clusters.

The term “transaction” generally refers to a set of one or more data operations that are grouped together, such that either all of these operations execute and have their corresponding results committed, or none of these results are committed. A transaction is typically executed in two phases. In a first phase, all operations in the transaction are executed, and the results are saved in a temporary storage. In a second phase, the results are written to databases within a database cluster. The second phase of writing the results to the databases is often referred to as committing the transaction. After the first phase is completed, a determination can be made as to whether or not it is desired to commit the transaction. In case of a conflict of synchronization, the transaction is rolled back, i.e., the temporary results are discarded and the databases are not modified.

The term “transaction identifier” generally refers to a unique identifier assigned to a given transaction. Optionally, a transaction identifier of a given transaction includes a node identifier that identifies a given node from which the given transaction originated. As an example, the node identifier can be a Universally Unique Identifier (UUID) of the given node.

The term “database object” generally refers to a logical group of data elements. Examples of a database object include, but are not limited to, a database table, a database schema and a database table partition.

The term “primary component” generally refers to a part of a database cluster, wherein nodes that are included in the primary component are able to communicate with each other. In an embodiment, a primary component of a given database cluster is elected by a cluster quorum. It is to be noted here that the cluster quorum may elect a minor component of a given database cluster as its primary component. In other words, a primary component can even have a single node. It will be appreciated that there can be multiple components within a given database cluster, wherein nodes that are included in these components are able to communicate with each other. However, there can be at most one primary component within a given database cluster.

The term “owner cluster” generally refers to a database cluster that is assigned as an owner to a given database object, such that only nodes included in a primary component of the owner cluster are allowed to commit transactions modifying the given database object.

The term “replication log” generally refers to a memory cache maintained at a given node that is used for caching transactions committed at the given node for a particular database cluster.

The term “client” generally refers to an application, program, process or device in a client/server relationship that requests information or services from another program, process or device (a server) on a communication network. Importantly, the terms “client” and “server” are relative since an application may be a client to one application but a server to another. The term “client” also encompasses software that makes the connection between a requesting application, program, process or device to a server possible, such as an FTP client.

The term “server” generally refers to an application, program, process or device in a client/server relationship that responds to requests for information or services by another program, process or device (a client) on a communication network. The term “server” also encompasses software that makes the act of serving information or providing services possible.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the present disclosure provided herein, one of ordinary skill in the art will appreciate a variety of ways in which connection or coupling exists in accordance with the aforementioned definition.

The phrases “in an embodiment,” “in accordance with an embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

If the specification states a component or feature “may”, “can”, “could”, or “might” be included or have a characteristic, that particular component or feature is not required to be included or have the characteristic.

### EMBODIMENTS OF THE PRESENT DISCLOSURE

In a first aspect, embodiments of the present disclosure provide a method for use in a multi-cluster database arrangement, the multi-cluster database arrangement comprising a plurality of database clusters, wherein at least two database clusters of the multi-cluster database arrangement are overlapping, wherein each database object defined in the multi-cluster database arrangement is assigned an owner cluster from amongst the plurality of database clusters, the method comprising:

(a) receiving a given transaction at a given node of the multi-cluster database arrangement;
(b) determining a database object being modified by the given transaction, whilst executing the given transaction at the given node;
(c) determining a given owner cluster assigned to the database object;
(d) determining whether or not the given node is included in a primary component of the given owner cluster; and
(e) committing the given transaction at the given node for the given owner cluster, when the given node is included in the primary component of the given owner cluster,
further wherein (b) to (e) are performed when the given transaction is received at (a) during a time the given node is communicably disjoint from at least one other node of the given owner cluster.

It is to be noted here that the given node is communicably disjoint from the at least one other node when there is no network connectivity between the given node and the at least one other node.

Optionally, primary components of all the database clusters are pre-defined in the multi-cluster database arrangement. Optionally, these primary components are re-defined, when a new node joins or an existing node drops from the multi-cluster database arrangement.

Optionally, the primary components of the database clusters are defined based upon one or more parameters. More optionally, the primary components are defined based upon a weight parameter, for example as will be elucidated in conjunction with an example later.

According to an embodiment, when the given node is included in the primary component of the given owner cluster, the method further comprises communicating a replication write-set of the given transaction to the at least one other node when the at least one other node rejoins the given owner cluster. The at least one other node is said to have rejoined the given owner cluster when a network connectivity is re-established between the given node and the at least one other node.

According to an embodiment, when the given node is included in the primary component of the given owner cluster, the method further comprises:

receiving, from the at least one other node, a transaction identifier of a last transaction that was committed at the at least one other node for the given owner cluster;

identifying transactions that were committed at the given node for the given owner cluster during the time the given node was communicably disjoint from the at least one other node, based on the transaction identifier of the last transaction; and

communicating replication write-sets of the identified transactions to the at least one other node.

Optionally, in this regard, the method further comprises:

maintaining a replication log at the given node, wherein the replication log stores transaction identifiers of transactions committed at the given node for the given owner cluster; and

looking up for the transaction identifier of the last transaction in the replication log to identify the transactions that were committed at the given node for the given owner cluster during the time the given node was communicably disjoint from the at least one other node.

Optionally, the replication log is configured to have a fixed size. Optionally, the replication log is implemented by way of a ring buffer. If the size of the replication log is too small, the replication log may roll over before the at least one other node rejoins the given owner cluster. On the other hand, if the size of the replication log is too big, the replication log may waste resources unnecessarily. Therefore, the size of the replication log is optionally adjusted based on a rate at which transactions are being received at the given node and/or a size of the transactions. This enables the replication log to store transactions for usual network connectivity loss.

However, it will be appreciated that rolling over of the replication log is not fatal. The roll over only makes it difficult to synchronize the at least one other node with the given owner cluster. When the replication log rolls over, the given node has to send a full copy of its database to the at least one other node.

Optionally, the given node maintains a corresponding replication log for each database cluster of which the given node is a member. Optionally, in this regard, a replication log for a particular database cluster stores transaction identifiers of transactions committed at the given node for that particular database cluster.

According to an embodiment, the method further comprises declining the given transaction at the given node, when the given node is not included in the primary component of the given owner cluster.

Moreover, according to an embodiment, the database object is selected from the group consisting of a database table, a database schema and a database table partition.

According to an embodiment, a database administrator of the multi-cluster database arrangement assigns an owner cluster to each database object defined in the multi-cluster database arrangement. Optionally, in this regard, metadata of a given database object includes a new attribute to designate a given database cluster that owns the given database object.

Furthermore, the aforementioned method can be implemented in hardware, software, or a combination thereof.

For illustration purposes only, there will now be considered an example of how the aforementioned method can be executed in a multi-cluster database arrangement. The example pertains to a retail store scenario, wherein the multi-cluster database arrangement includes two Head Quarter (HQ) nodes, namely nodes HQ-1 and HQ-2, and three retail store nodes, namely nodes A, B and C. For the sake of convenience, the nodes HQ-1 and HQ-2 are hereinafter collectively referred to as “HQ nodes”.

Each retail store node is a member of two database clusters, namely a store cluster corresponding to that retail store node and a HQ cluster. A store cluster corresponding to the node A (hereinafter referred to as “store cluster A”) includes the node A and the HQ nodes, wherein the node A is included in a primary component of the store cluster A. Likewise, a store cluster corresponding to the node B (hereinafter referred to as “store cluster B”) includes the node B and the HQ nodes, wherein the node B is included in a primary component of the store cluster B. Likewise, a store cluster corresponding to the node C (hereinafter referred to as “store cluster C”) includes the node C and the HQ nodes, wherein the node C is included in a primary component of the store cluster C.

Moreover, the HQ cluster includes the HQ nodes and the nodes A, B and C, wherein the HQ nodes are included in a primary component of the HQ cluster.

Optionally, the aforementioned primary components of all the clusters, namely the HQ cluster, the store cluster A, the store cluster B and the store cluster C, are pre-defined in the multi-cluster database arrangement. Optionally, these primary components are re-defined, when a new node joins or an existing node drops from the multi-cluster database arrangement.

Optionally, the primary components of the clusters are defined based upon one or more parameters. More optionally, the primary components are defined based upon a weight parameter. In the illustrated example, the retail store nodes, namely the nodes A, B and C, have less weightage in the HQ cluster and more weightage in their respective clusters, namely in the store cluster A, the store cluster B and the store cluster C, respectively. On the other hand, the HQ nodes have more weightage in the HQ cluster and less weightage in the store cluster A, the store cluster B and the store cluster C.

Moreover, each database object defined in the multi-cluster database arrangement is assigned an owner cluster from amongst the aforementioned database clusters, namely from amongst the HQ cluster, the store cluster A, the store cluster B and the store cluster C. According to an embodiment, a database administrator of the multi-cluster database arrangement assigns owner clusters to database objects defined in the multi-cluster database arrangement.

As an example, the store cluster A is assigned as an owner cluster to at least one database table that stores information specific to the node A, for example, including information pertaining to retail transactions that have been made at the node A. Likewise, the store cluster B is assigned as an owner cluster to at least one database table that stores information specific to the node B. Likewise, the store cluster C is assigned as an owner cluster to at least one database table that stores information specific to the node C.

When there is network connectivity between the nodes A, B, C, HQ-1 and HQ-2, all the clusters in the multi-cluster database arrangement, namely the HQ cluster, the store cluster A, the store cluster B and the store cluster C, operate together as a single large cluster. In other words, when a given transaction is received at any of the nodes A, B, C, HQ-1 and HQ-2 during the time of network connectivity, the receiving node acts as a master node and remaining nodes act as slave nodes.

However, when network connectivity is lost, for example, between any two clusters, they begin to operate as separate functional clusters, as will be elucidated in more detail below.

For the sake of clarity only, an implementation of the aforementioned method will now be elucidated with reference to the node A.

During a time when there is network connectivity between the node A and the HQ nodes, a transaction received at any of the nodes A, HQ-1 and HQ-2 is processed as usual, for example, as explained in more detail below.

When a given transaction for the store cluster A is received at any of the nodes A, HQ-1 and HQ-2 during the time of network connectivity, the receiving node acts as a master node and remaining nodes act as slave nodes. In this regard, the receiving node executes the given transaction and communicates a replication write-set of the given transaction to the remaining nodes. If no conflict is detected during certification, the receiving node commits the given transaction, while the remaining nodes execute and commit the given transaction.

Likewise, when a given transaction for the HQ cluster is received at any of the nodes A, HQ-1 and HQ-2 during the time of network connectivity, the receiving node acts as a master node and remaining nodes act as slave nodes.

In this manner, the nodes A, HQ-1 and HQ-2 process transactions received during the time of network connectivity, irrespective of whether these transactions modify database objects owned by the store cluster A or database objects owned by the HQ cluster. In other words, when connected, all of the nodes A, HQ-1 and HQ-2 process transactions modifying database objects owned by the store cluster A as well as transactions modifying database objects owned by the HQ cluster.

During a time the node A is communicably disjoint from the HQ nodes, the store cluster A and the HQ cluster become disjoint automatically and operate as separate functional clusters, as explained in more detail below. The store cluster A continues to operate as a single node cluster, wherein an only node included in its primary component, namely the node A, is allowed to commit transactions modifying database objects owned by the store cluster A. Meanwhile, the HQ cluster continues to operate in a manner that nodes included in its primary component, namely the HQ nodes, are allowed to commit transactions modifying database objects owned by the HQ cluster.

If, during the time the node A is communicably disjoint from the HQ nodes, a transaction modifying a database object owned by the HQ cluster is received at the node A, the node A declines the transaction. In this regard, an error code can be sent to a client that initiated the transaction at the node A. Likewise, if, during the time the node A is communicably disjoint from the HQ nodes, a transaction modifying a database object owned by the store cluster A is received at any of the HQ nodes, the receiving node declines the transaction.

In this manner, during the time the node A is communicably disjoint from the HQ nodes, a given database object is modified only in one of the disjoint clusters, namely in an owner cluster assigned to the given database object. In other words, when disconnected, the nodes A, HQ-1 and HQ-2 process only those transactions that modify database objects owned by their respective clusters, thereby committing only “safe” writes. This guarantees that no write conflicts occur in the disjoint clusters.

Moreover, each of the nodes A, HQ-1 and HQ-2 maintains a first replication log of transactions that have been committed at that node for the store cluster A, namely transactions modifying database objects owned by the store cluster A that have been committed at that node. Each of the nodes A, HQ-1 and HQ-2 also maintains a second replication log of transactions that have been committed at that node for the HQ cluster, namely transactions modifying database objects owned by the HQ cluster that have been committed at that node. Such replication logs store transaction identifiers of committed transactions.

Optionally, when the node A becomes communicably disjoint from the HQ nodes, the node A stores, in its persistent data storage, a transaction identifier of a last transaction that was committed at the node A for the HQ cluster. Storing the transaction identifier of the last transaction in the persistent data storage enables the node A to recover even when a complete node crash occurs at the node A. Likewise, the HQ nodes store, in their persistent data storage, a transaction identifier of a last transaction that was committed at the HQ nodes for the store cluster A.

When a network connection between the node A and the HQ nodes is re-established, the node A rejoins the HQ cluster and the HQ nodes rejoin the store cluster A. Such rejoining occurs automatically pursuant to embodiments of the present disclosure.

Consequently, the node A retrieves, from its persistent data storage or its second replication log, the transaction identifier of the last transaction that was committed at the node A for the HQ cluster. The node A then communicates the retrieved transaction identifier to at least one of the HQ nodes. The at least one of the HQ nodes then looks up for the transaction identifier in its second replication log to identify transactions that were committed at the HQ nodes for the HQ cluster during the time the node A was communicably disjoint from the HQ nodes. Subsequently, the at least one of the HQ nodes communicates replication write-sets of the identified transactions to the node A. Optionally, in this regard, the at least one of the HQ nodes builds a batch of the identified transactions and communicates the batch to the node A. As writing permissions were restricted during the time the node A was communicably disjoint from the HQ nodes, the batch of the identified transactions is committed safely at the node A, namely without any write conflicts. This enables the node A to synchronize automatically with the HQ cluster.

Likewise, the HQ nodes retrieve, from their persistent data storage or their first replication log, the transaction identifier of the last transaction that was committed at the HQ nodes for the store cluster A. The HQ nodes then communicate the retrieved transaction identifier to the node A. The node A then looks up for this transaction identifier in its first replication log to identify transactions that were committed at the node A for the store cluster A during the time the node A was communicably disjoint from the HQ nodes. Subsequently, the node A communicates replication write-sets of these identified transactions to the HQ nodes. Optionally, in this regard, the node A builds a batch of the identified transactions and communicates the batch to the HQ nodes. As writing permissions were restricted during the time the node A was communicably disjoint from the HQ nodes, the batch of the identified transactions is committed safely at the HQ nodes, namely without any write conflicts. This enables the HQ nodes to synchronize automatically with the store cluster A.

Upon synchronizing with the HQ cluster, the node A rejoins the HQ cluster and begins to accept transactions for the HQ cluster. Likewise, upon synchronizing with the store cluster A, the HQ nodes rejoin the store cluster A and begin to accept transactions for the store cluster A.

It is to be noted here that the aforementioned method is implemented in a similar manner at the nodes B and C. During a time when there is network connectivity between the node B and the HQ nodes, a transaction received at any of the nodes B, HQ-1 and HQ-2 is processed as usual, for example, as explained earlier. During a time the node B is communicably disjoint from the HQ nodes, the store cluster B and the HQ cluster operate as separate functional clusters, as explained earlier. In this regard, the store cluster B continues to operate as a single node cluster, wherein an only node included in its primary component, namely the node B, is allowed to commit transactions modifying database objects owned by the store cluster B.

Likewise, during a time when there is network connectivity between the node C and the HQ nodes, a transaction received at any of the nodes C, HQ-1 and HQ-2 is processed as usual, for example, as explained earlier. During a time the node C is communicably disjoint from the HQ nodes, the store cluster C and the HQ cluster operate as separate functional clusters, as explained earlier. In this regard, the store cluster C continues to operate as a single node cluster, wherein an only node included in its primary component, namely the node C, is allowed to commit transactions modifying database objects owned by the store cluster C.

In this manner, the aforementioned method guarantees that no write conflicts occur in the multi-cluster database arrangement even when the database clusters become temporarily disjoint.

In a second aspect, embodiments of the present disclosure provide a computing apparatus comprising:

a processor;

a memory coupled to the processor; and

a network interface coupled to the processor,

wherein the processor is configured to:

(i) receive a given transaction;

(ii) determine a database object being modified by the given transaction, whilst executing the given transaction;

(iii) determine a given owner cluster assigned to the database object;

(iv) determine whether or not the computing apparatus is included in a primary component of the given owner cluster; and

(v) commit the given transaction for the given owner cluster, when the computing apparatus is included in the primary component of the given owner cluster,

further wherein (ii) to (v) are performed when the given transaction is received at (i) during a time the computing apparatus is communicably disjoint from at least one other node of the given owner cluster.

According to an embodiment, the processor is configured to communicate a replication write-set of the given transaction to the at least one other node when the at least one other node rejoins the given owner cluster. The at least one other node is said to have rejoined the given owner cluster when a network connectivity is re-established between the computing apparatus and the at least one other node.

According to an embodiment, the processor is configured to:

receive, from the at least one other node, a transaction identifier of a last transaction that was committed at the at least one other node for the given owner cluster;

identify transactions that were committed at the computing apparatus for the given owner cluster during the time the computing apparatus was communicably disjoint from the at least one other node, based on the transaction identifier of the last transaction; and

communicate replication write-sets of the identified transactions to the at least one other node.

Optionally, in this regard, the processor is configured to:

maintain a replication log, wherein the replication log stores transaction identifiers of transactions committed at the computing apparatus for the given owner cluster; and

look up for the transaction identifier of the last transaction in the replication log to identify the transactions that were committed at the computing apparatus for the given owner cluster during the time the computing apparatus was communicably disjoint from the at least one other node.

According to an embodiment, the processor is configured to decline the given transaction, when the computing apparatus is not included in the primary component of the given owner cluster.

Moreover, according to an embodiment, the database object is selected from the group consisting of a database table, a database schema and a database table partition.

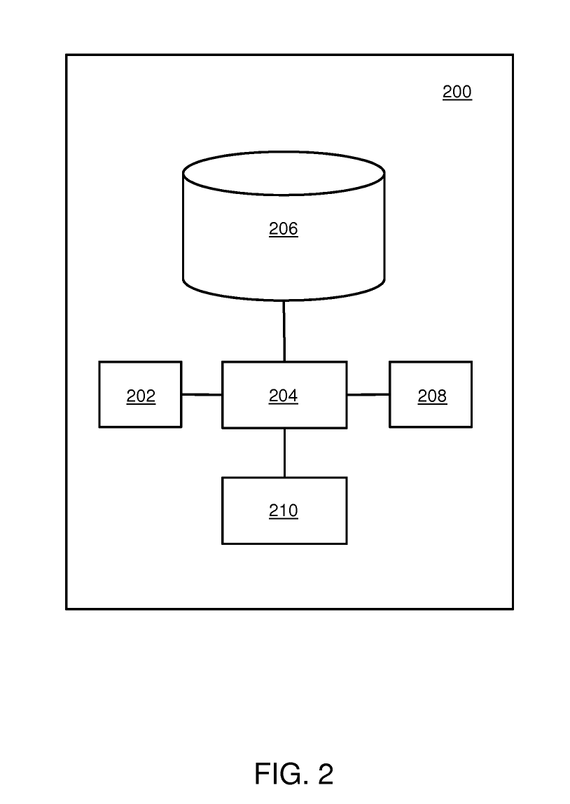

Furthermore, an example of a computing apparatus has been provided in conjunction with FIG. 2 as explained in more detail below. The computing apparatus could be a database server, or a computing device dedicated to running processes associated with databases.

The computing apparatus includes, but is not limited to, a memory, a processor, a data storage, a network interface, and a power source.

The power source supplies electrical power to various components of the computing apparatus. The power source may, for example, include a rechargeable battery.

The memory optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

The data storage is a non-transitory data storage arrangement, for example, including a database.

The network interface optionally allows clients to access the computing apparatus, and perform read and/or write operations on the database.

Moreover, the network interface enables the computing apparatus to communicate with other computing apparatus, for example, via a communication network.

Moreover, the processor is configured to perform operations as described earlier.

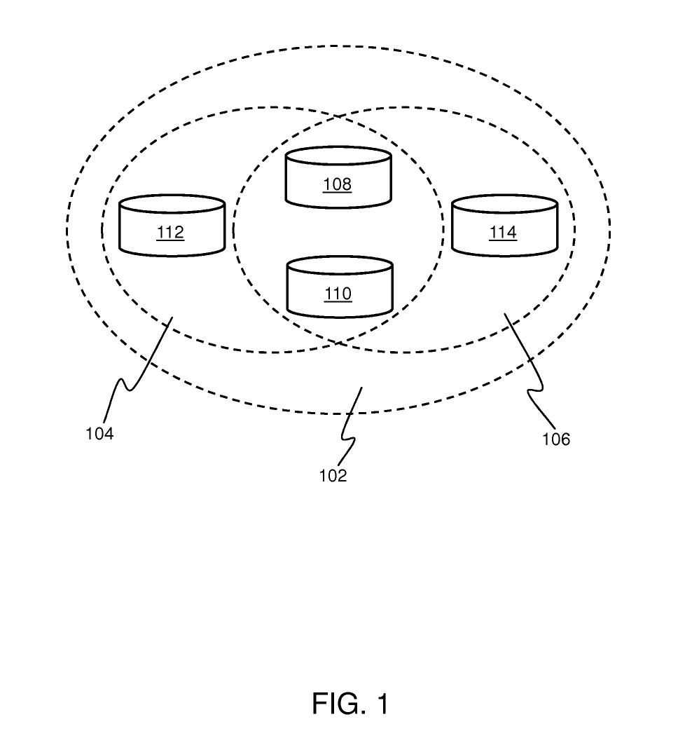

Furthermore, embodiments of the present disclosure also provide a multi-cluster database arrangement that includes a plurality of database clusters. An example of such a multi-cluster database arrangement has been provided in conjunction with FIG. 1 as explained in more detail below.

At least two database clusters of the multi-cluster database arrangement are overlapping. By definition, when database clusters overlap, they have at least one node in common.

Nodes of the multi-cluster database arrangement may, for example, be database servers, processes associated with databases, or computing devices dedicated to running such processes. The nodes may be implemented in a manner that is similar to an implementation of the aforementioned computing apparatus.

The nodes may be installed at separate hardware or at same hardware. In an example, the nodes are optionally distributed geographically. In another example, the nodes are optionally implemented as a cloud service.

Optionally, a communication network couples some or all of the nodes in communication for exchanging data amongst the nodes.

Additionally or alternatively, optionally, some of the nodes are coupled in communication via another communication network that is isolated from the communication network.

Additionally or alternatively, optionally, some of the nodes are coupled in communication via non-network means, for example, such as Unix domain sockets.

The communication network can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Optionally, the communication network also provides a communication medium between clients and the nodes. Consequently, the clients are operable to access the nodes via the communication network. In some examples, the clients are web services that allow users to access the nodes. Accordingly, the clients are optionally operable to perform read and/or write operations on the nodes.

Moreover, each database object defined in the multi-cluster database arrangement is assigned an owner cluster from amongst the plurality of database clusters.

When a given database cluster breaks up, only nodes included in a primary component of the given database cluster remain active and are allowed to commit transactions modifying database objects that are owned by the given database cluster. This guarantees that no write conflicts occur in the multi-cluster database arrangement when the given database cluster becomes disjoint.

In a third aspect, embodiments of the present disclosure provide a method for use in a multi-cluster database arrangement, the multi-cluster database arrangement comprising a plurality of database clusters, wherein at least two database clusters of the multi-cluster database arrangement are overlapping, the method comprising:

assigning, to each database object defined in the multi-cluster database arrangement, an owner cluster from amongst the plurality of database clusters; and

defining a primary component of each database cluster, wherein a primary component of a given database cluster includes at least one node of the given database cluster that remains active and is allowed to commit transactions modifying database objects that are assigned the given database cluster as their owner cluster, when the at least one node is disjoint from other nodes of the given database cluster.

According to an embodiment, the database object is selected from the group consisting of a database table, a database schema and a database table partition.

Optionally, metadata of a given database object includes a new attribute to designate a given database cluster that owns the given database object.

### DETAILED DESCRIPTION OF THE DRAWINGS

Referring now to the drawings, particularly by their reference numbers, FIG. 1 is a schematic illustration of an example multi-cluster database arrangement 100, in accordance with an embodiment of the present disclosure. The multi-cluster database arrangement 100 includes a plurality of database clusters, depicted as a database cluster 102, a database cluster 104 and a database cluster 106 in FIG. 1.

With reference to FIG. 1, the database cluster 102 includes nodes 108, 110, 112 and 114, wherein the nodes 108 and 110 are included in a primary component of the database cluster 102. The database cluster 104 includes the nodes 108, 110 and 112, wherein the node 112 is included in a primary component of the database cluster 104. The database cluster 106 includes the nodes 108, 110 and 114, wherein the node 114 is included in a primary component of the database cluster 106. With reference to FIG. 1, each node in the multi-cluster database arrangement 100 is common in at least two database clusters.

FIG. 1 is merely an example, which should not unduly limit the scope of the claims herein. It is to be understood that the specific designation for the multi-cluster database arrangement 100 is provided as an example and is not to be construed as limiting the multi-cluster database arrangement 100 to specific numbers, types, or arrangements of database clusters and nodes. A person skilled in the art will recognize many variations, alternatives, and modifications of embodiments of the present disclosure.

FIG. 2 is a schematic illustration of a computing apparatus 200 for use in a multi-cluster database arrangement, in accordance with an embodiment of the present disclosure. The computing apparatus 200 includes, but is not limited to, a memory 202, a processor 204, a data storage 206, a network interface 208, and a power source 210.

FIG. 2 is merely an example, which should not unduly limit the scope of the claims herein. It is to be understood that the specific designation for the computing apparatus 200 is provided as an example and is not to be construed as limiting the computing apparatus 200 to specific numbers, types, or arrangements of modules and/or components of the computing apparatus 200. A person skilled in the art will recognize many variations, alternatives, and modifications of embodiments of the present disclosure.

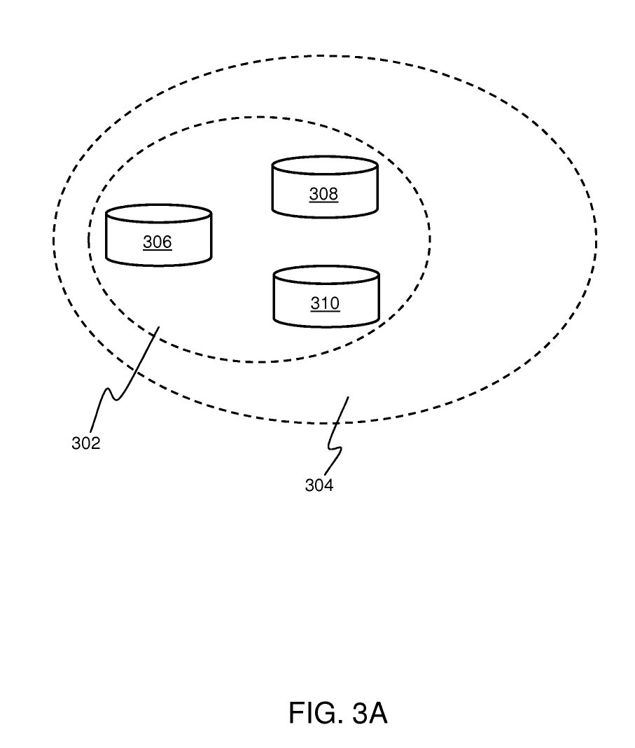

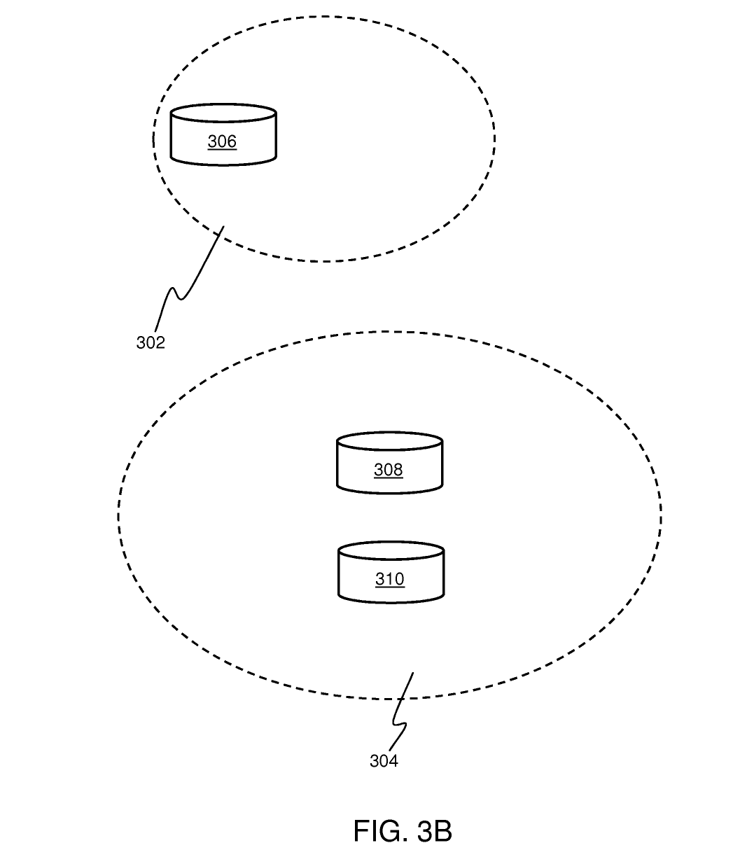

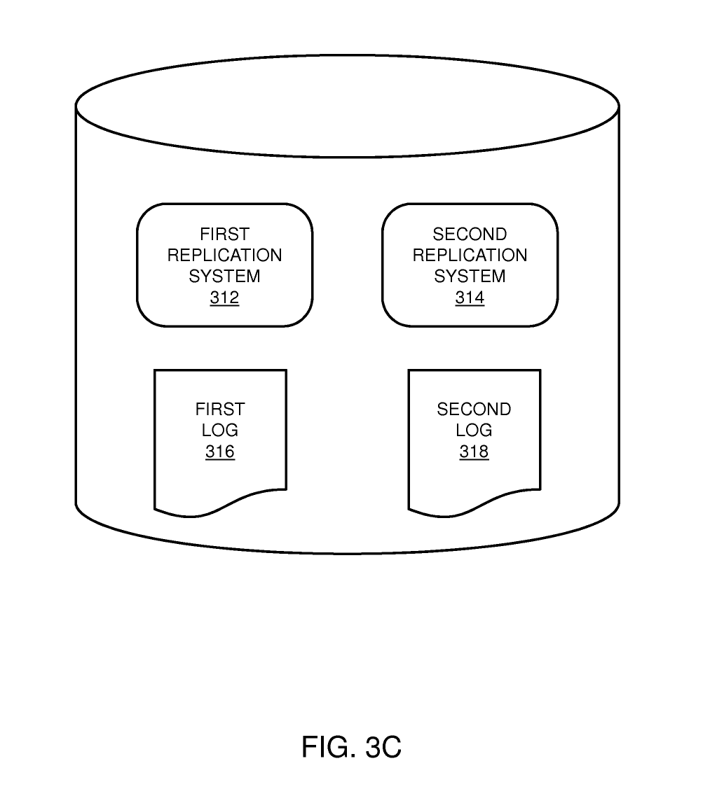

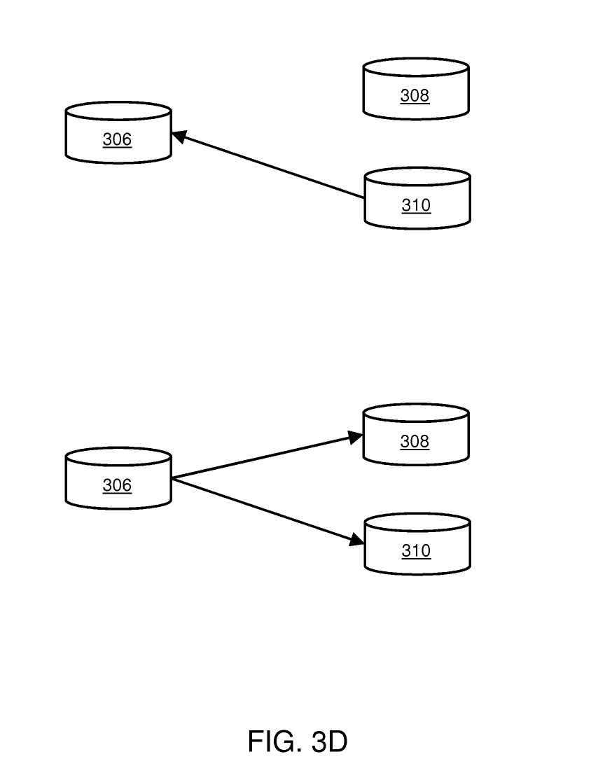

FIGS. 3A, 3B, 3C and 3D collectively are a schematic illustration of an example multi-cluster database arrangement and processing performed thereat under various scenarios, in accordance with an embodiment of the present disclosure.

With reference to FIG. 3A, the example multi-cluster database arrangement includes database clusters 302 and 304. The database cluster 302 includes nodes 306, 308 and 310, wherein the node 306 is included in a primary component of the database cluster 302. The database cluster 304 includes the nodes 306, 308 and 310, wherein the nodes 308 and 310 are included in a primary component of the database cluster 304.

It is to be noted here that the example multi-cluster database arrangement is not limited to a certain number of database clusters, and can include any number of database clusters. Moreover, the database clusters 302 and 304 are not limited to a certain number of nodes, and can include other nodes, whether or not included in their primary components, in addition to the nodes 306, 308 and 310.

In FIG. 3B, there is shown a first scenario where the database clusters 302 and 304 become temporarily disjoint when the node 306 becomes communicably disjoint from the nodes 308 and 310. In the first scenario, only the node 306 is allowed to commit transactions modifying database objects that are owned by the database cluster 302, while only the nodes 308 and 310 are allowed to commit transactions modifying database objects that are owned by the database cluster 304.

Each of the nodes 306, 308 and 310 includes two separate replication systems for the database clusters 302 and 304, depicted as a first replication system 312 and a second replication system 314 in FIG. 3C.

Moreover, each of the nodes 306, 308 and 310 maintains two separate replication logs for the database clusters 302 and 304, depicted as a first replication log 316 and a second replication log 318 in FIG. 3C.

In FIG. 3D, there is shown a second scenario where the node 306 rejoins the database cluster 304, and the nodes 308 and 310 rejoin the database cluster 302, when a network connection between the node 306 and the nodes 308 and 310 is re-established. As a consequence, the node 306 sends to any of the nodes 308 and 310 a transaction identifier of a last transaction committed at the node 306 for the database cluster 304. With reference to FIG. 3D, the node 310 communicates write-sets of transactions that were committed at the node 310 for the database cluster 304 during a time the node 306 was communicably disjoint from the nodes 308 and 310.

Likewise, the nodes 308 and 310 send to the node 306 a transaction identifier of a last transaction committed at the nodes 308 and 310 for the database cluster 302. With reference to FIG. 3D, the node 306 communicates write-sets of transactions that were committed at the node 306 for the database cluster 302 during the time the node 306 was communicably disjoint from the nodes 308 and 310.

In this manner, the nodes 306, 308 and 310 synchronize automatically.

FIGS. 3A-D are merely examples, which should not unduly limit the scope of the claims herein. A person skilled in the art will recognize many variations, alternatives, and modifications of embodiments of the present disclosure.

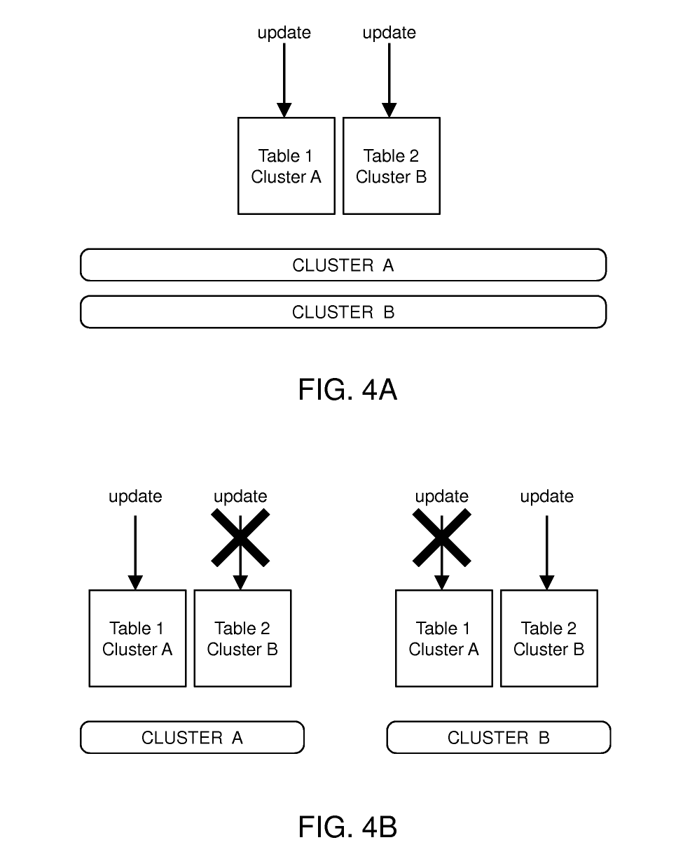

FIGS. 4A and 4B collectively are a schematic illustration of processing performed at a multi-cluster database arrangement, in accordance with an embodiment of the present disclosure.

The multi-cluster database arrangement includes two database clusters, namely a cluster A and a cluster B. For illustration purposes only, let us consider that the clusters A and B include same nodes, but have different nodes in their primary components. The cluster A is assigned as an owner cluster to a database table ‘table 1’, while the cluster B is assigned as an owner cluster to a database table ‘table 2’.

In FIG. 4A, there is shown a scenario where the clusters A and B are not disjoint. In such a scenario, each node is allowed to commit transactions modifying the database table ‘table 1’, irrespective of whether or not that node is included in the primary component of the cluster A. Likewise, each node is allowed to commit transactions modifying the database table ‘table 2’, irrespective of whether or not that node is included in the primary component of the cluster B.

In FIG. 4B, there is shown another scenario where the clusters A and B become temporarily disjoint. In such a scenario, only nodes included in the primary component of the cluster A are allowed to commit transactions modifying the database table ‘table 1’, while only nodes included in the primary component of the cluster B are allowed to commit transactions modifying the database table ‘table 2’.

FIGS. 4A-B are merely examples, which should not unduly limit the scope of the claims herein. A person skilled in the art will recognize many variations, alternatives, and modifications of embodiments of the present disclosure.

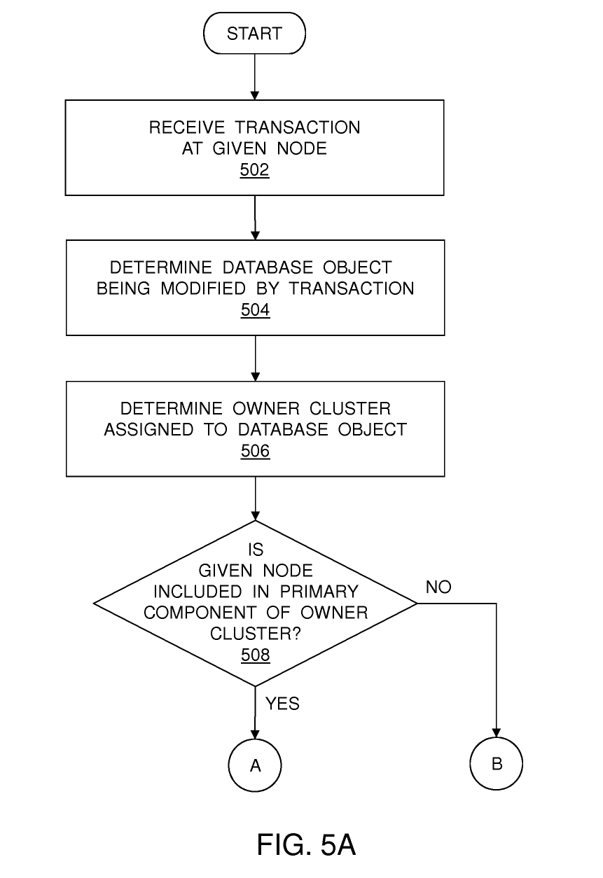

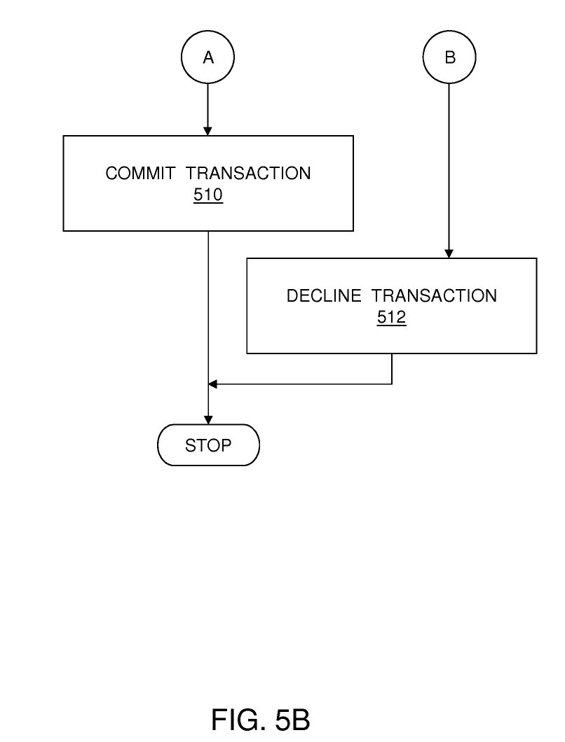

FIGS. 5A and 5B collectively are an illustration of steps of a method for use in a multi-cluster database arrangement, in accordance with an embodiment of the present disclosure. The method is depicted as a collection of steps in a logical flow diagram, which represents a sequence of steps that can be implemented in hardware, software, or a combination thereof.

The multi-cluster database arrangement includes a plurality of database clusters. At least two database clusters of the multi-cluster database arrangement are overlapping. Each database object defined in the multi-cluster database arrangement is assigned an owner cluster from amongst the plurality of database clusters.

At a step 502, a given transaction is received at a given node of the multi-cluster database arrangement.

At a step 504, the given node determines a database object being modified by the given transaction, whilst executing the given transaction.

At a step 506, the given node determines a given owner cluster assigned to the database object.

At a step 508, it is determined whether or not the given node is included in a primary component of the given owner cluster.

If, at the step 508, it is determined that the given node is included in the primary component of the given owner cluster, a step 510 is performed. At the step 510, the given node commits the given transaction for the given owner cluster.

If, at the step 508, it is determined that the given node is not included in the primary component of the given owner cluster, a step 512 is performed. At the step 512, the given node declines the given transaction.

The steps 504 to 512 are performed when the given transaction is received at the step 502 during a time the given node is communicably disjoint from at least one other node of the given owner cluster.

It should be noted here that the steps 502 to 512 are only illustrative and other alternatives can also be provided where one or more steps are added, one or more steps are removed, or one or more steps are provided in a different sequence without departing from the scope of the claims herein.

Embodiments of the present disclosure are susceptible to being used for various purposes, including, though not limited to, enabling conflict-free transaction processing and synchronization at temporarily disjoint nodes in a multi-cluster database arrangement.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for use in a multi-cluster database arrangement, the multi-cluster database arrangement comprising a plurality of database clusters, wherein at least two database clusters of the multi-cluster database arrangement are overlapping, wherein each database object defined in the multi-cluster database arrangement is assigned an owner cluster from amongst the plurality of database clusters, the method comprising:
(a) receiving a given transaction at a given node of the multi-cluster database arrangement;
(b) determining a database object being modified by the given transaction, whilst executing the given transaction at the given node;
(c) determining a given owner cluster assigned to the database object;
(d) determining whether or not the given node is included in a primary component of the given owner cluster; and
(e) committing the given transaction at the given node for the given owner cluster, when the given node is included in the primary component of the given owner cluster,
further wherein (b) to (e) are performed when the given transaction is received at (a) during a time the given node is communicably disjoint from at least one other node of the given owner cluster.

2. The method of claim 1, wherein when the given node is included in the primary component of the given owner cluster, the method further comprises communicating a replication write-set of the given transaction to the at least one other node when the at least one other node rejoins the given owner cluster, wherein the at least one other node rejoins the given owner cluster when a network connectivity is re-established between the given node and the at least one other node.

3. The method of claim 1, wherein when the given node is included in the primary component of the given owner cluster, the method further comprises:
receiving, from the at least one other node, a transaction identifier of a last transaction that was committed at the at least one other node for the given owner cluster;
identifying transactions that were committed at the given node for the given owner cluster during the time the given node was communicably disjoint from the at least one other node, based on the transaction identifier of the last transaction; and
communicating replication write-sets of the identified transactions to the at least one other node.

4. The method of claim 3, wherein the method further comprises:
maintaining a replication log at the given node, wherein the replication log stores transaction identifiers of transactions committed at the given node for the given owner cluster; and
looking up for the transaction identifier of the last transaction in the replication log to identify the transactions that were committed at the given node for the given owner cluster during the time the given node was communicably disjoint from the at least one other node.

5. The method of claim 1, wherein the method further comprises declining the given transaction at the given node, when the given node is not included in the primary component of the given owner cluster.

6. The method of claim 1, wherein the database object is selected from the group consisting of a database table, a database schema and a database table partition.

7. A computing apparatus comprising:
a processor;
a memory coupled to the processor; and
a network interface coupled to the processor,
wherein the processor is configured to:
(i) receive a given transaction;
(ii) determine a database object being modified by the given transaction, whilst executing the given transaction;
(iii) determine a given owner cluster assigned to the database object;
(iv) determine whether or not the computing apparatus is included in a primary component of the given owner cluster; and
(v) commit the given transaction for the given owner cluster, when the computing apparatus is included in the primary component of the given owner cluster,
further wherein (ii) to (v) are performed when the given transaction is received at (i) during a time the computing apparatus is communicably disjoint from at least one other node of the given owner cluster.

8. The apparatus of claim 7, wherein the processor is configured to communicate a replication write-set of the given transaction to the at least one other node when the at least one other node rejoins the given owner cluster, wherein the at least one other node rejoins the given owner cluster when a network connectivity is re-established between the computing apparatus and the at least one other node.

9. The apparatus of claim 7, wherein the processor is configured to:
receive, from the at least one other node, a transaction identifier of a last transaction that was committed at the at least one other node for the given owner cluster;
identify transactions that were committed at the computing apparatus for the given owner cluster during the time the computing apparatus was communicably disjoint from the at least one other node, based on the transaction identifier of the last transaction; and
communicate replication write-sets of the identified transactions to the at least one other node.

10. The apparatus of claim 9, wherein the processor is configured to:
maintain a replication log, wherein the replication log stores transaction identifiers of transactions committed at the computing apparatus for the given owner cluster; and
look up for the transaction identifier of the last transaction in the replication log to identify the transactions that were committed at the computing apparatus for the given owner cluster during the time the computing apparatus was communicably disjoint from the at least one other node.

11. The apparatus of claim 7, wherein the processor is configured to decline the given transaction, when the computing apparatus is not included in the primary component of the given owner cluster.

12. The apparatus of claim 7, wherein the database object is selected from the group consisting of a database table, a database schema and a database table partition.

13. A method for use in a multi-cluster database arrangement, the multi-cluster database arrangement comprising a plurality of database clusters, wherein at least two database clusters of the multi-cluster database arrangement are overlapping, the method comprising:
assigning, to each database object defined in the multi-cluster database arrangement, an owner cluster from amongst the plurality of database clusters; and
defining a primary component of each database cluster, wherein a primary component of a given database cluster includes at least one node of the given database cluster that remains active and is allowed to commit transactions modifying database objects that are assigned the given database cluster as their owner cluster, when the at least one node is disjoint from other nodes of the given database cluster.

14. The method of claim 13, wherein the database object is selected from the group consisting of a database table, a database schema and a database table partition.
